(19) United States
(12) Patent Application Publication
(10) Pub. No.: US 2019/0246036 A1
(43) Pub. Date: Aug. 8, 2019

(54) GESTURE- AND GAZE-BASED VISUAL DATA ACQUISITION SYSTEM

(71) Applicant: Futurewei Technologies, Inc., Plano, TX (US)

(72) Inventors: Yitian Wu, San Jose, CA (US); Fatih Porikli, San Jose, CA (US); Lei Yang, Fremont, CA (US); Luis Bill, Daly City, CA (US)

(21) Appl. No.: 15/887,665

(22) Filed: Feb. 2, 2018

(51) Int. Cl. H04N 5/232; G06F 3/01; G06K 9/00

(52) U.S. Cl. CPC H04N 5/23219; G06F 3/013; G06K 9/00604; H04N 5/23216; G06K 9/00355; G06F 3/017

(57) ABSTRACT

A computer-implemented method of acquiring visual data is provided that comprises: determining, by one or more processors, a gaze point of a person in a vehicle; detecting, by the one or more processors, a gesture by the person in the vehicle; and in response to the detection of the gesture, causing, by the one or more processors, a camera to acquire visual data corresponding to the gaze point of the person.

### TECHNICAL FIELD

The present disclosure is related to gesture- and gaze-based controls and, in one particular embodiment, to gesture- and gaze-based visual data acquisition systems.

### BACKGROUND

With the wide popularity of smartphones with cameras, there is an increased urge to snap a photo while driving. The act of taking a picture with a smartphone requires one to unlock the screen, maybe enter a PIN or a specific swipe pattern, find the camera app, open it, frame the picture, and then click the shutter. Aside from not paying attention to the road while doing all of these things, during the act of framing the picture, the driver looks continuously at the scene to be captured, and tends to drive in the direction of the scene. Such a distraction, as well as using a hand-held device while driving, creates enormous potential for fatal crashes, deaths, and injuries on roads, and it is a serious traffic violation that could result in a driver disqualification.

### SUMMARY

Various examples are now described to introduce a selection of concepts in a simplified form that are further described below in the Detailed Description. The Summary is not intended to identify key or essential features of the claimed subject matter, nor is it intended to be used to limit the scope of the claimed subject matter.

According to one aspect of the present disclosure, there is provided a computer-implemented method of acquiring visual data that comprises: determining, by one or more processors, a gaze point of a person in a vehicle; detecting, by the one or more processors, a gesture by the person in the vehicle; and in response to the detection of the gesture, causing, by the one or more processors, a camera to capture visual data corresponding to the gaze point of the person.

Optionally, in any of the preceding embodiments, the gaze point of the person in the vehicle is a point outside of the vehicle.

Optionally, in any of the preceding embodiments, the determining of the gaze point of the person comprises determining a head pose of the person.

Optionally, in any of the preceding embodiments, the determining of the gaze point of the person comprises determining a gaze direction of the person.

Optionally, in any of the preceding embodiments, the determining of the gaze point of the person in the vehicle is based on an image captured by a first camera; and the camera caused to capture the visual data corresponding to the gaze point of the person is a second camera.

Optionally, in any of the preceding embodiments, the gesture is a hand gesture.

Optionally, in any of the preceding embodiments, the hand gesture comprises a thumb and a finger of one hand approaching each other.

Optionally, in any of the preceding embodiments, the vehicle is an automobile.

Optionally, in any of the preceding embodiments, the vehicle is an aircraft.

Optionally, in any of the preceding embodiments, the camera is integrated into the vehicle.

Optionally, in any of the preceding embodiments, the causing of the camera to capture the visual data comprises transmitting an instruction to a mobile device.

Optionally, in any of the preceding embodiments, the method further comprises: detecting a second gesture by the person in the vehicle; wherein the causing of the camera to capture the visual data corresponding to the gaze point of the person comprises causing the camera to zoom in on the gaze point based on the detection of the second gesture.

Optionally, in any of the preceding embodiments, the causing of the camera to capture the visual data corresponding to the gaze point of the person comprises causing the camera to compensate for a speed of the vehicle.

According to one aspect of the present disclosure, there is provided a vehicle that comprises: a memory storage comprising instructions; and one or more processors in communication with the memory storage, wherein the one or more processors execute the instructions to perform: determining a gaze point of a person in the vehicle; detecting a gesture by the person in the vehicle; and in response to the detection of the gesture, causing a camera to capture visual data corresponding to the gaze point of the person.

Optionally, in any of the preceding embodiments, the gaze point of the person in the vehicle is a point outside of the vehicle.

Optionally, in any of the preceding embodiments, the determining of the gaze point of the person in the vehicle is based on an image captured by a first camera; and the camera caused to capture the visual data corresponding to the gaze point of the person is a second camera.

Optionally, in any of the preceding embodiments, the gesture is a hand gesture.

Optionally, in any of the preceding embodiments, the hand gesture comprises a thumb and a finger of one hand approaching each other.

Optionally, in any of the preceding embodiments, the vehicle is an automobile.

According to one aspect of the present disclosure, there is provided a non-transitory computer-readable medium that stores computer instructions for acquiring visual data, that when executed by one or more processors, cause the one or more processors to perform steps of: determining a gaze point of a person in a vehicle; detecting a gesture by the person in the vehicle; and in response to the detection of the gesture, causing a camera to capture visual data corresponding to the gaze point of the person.

Any one of the foregoing examples may be combined with any one or more of the other foregoing examples to create a new embodiment within the scope of the present disclosure.

### BRIEF DESCRIPTION OF THE DRAWINGS

FIG. 1 is an illustration of a vehicle interior, according to some example embodiments.

FIG. 2 is an illustration of a vehicle exterior, according to some example embodiments.

FIG. 3 is an illustration of a view from a vehicle, according to some example embodiments.

FIG. 4 is an illustration of a gesture, according to some example embodiments.

FIG. 5 is an illustration of a gesture, according to some example embodiments.

FIG. 6 is a block diagram illustrating circuitry for a computer system that implements algorithms and performs methods, according to some example embodiments.

FIG. 7 is a block diagram of an example of an environment including a system for neural network training, according to some example embodiments.

FIG. 8 is a flowchart of a method for acquiring visual data based on gaze and gesture detection, according to some example embodiments.

FIG. 9 is a flowchart of a method for acquiring visual data based on gaze and gesture detection, according to some example embodiments.

FIG. 10 is a flowchart of a method for acquiring visual data based on gaze and gesture detection, according to some example embodiments.

FIG. 11 is a flowchart of a method for gaze detection, according to some example embodiments.

FIG. 12 is a flowchart of a method for gesture detection, according to some example embodiments.

FIG. 13 is an illustration of a camera following a driver's gaze, according to some example embodiments.

FIG. 14 is an illustration of a user interface showing acquired visual data, according to some example embodiments.

### DETAILED DESCRIPTION

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized and that structural, logical, and electrical changes may be made without departing from the scope of the present disclosure. The following description of example embodiments is, therefore, not to be taken in a limiting sense, and the scope of the present disclosure is defined by the appended claims.

The functions or algorithms described herein may be implemented in software, in one embodiment. The software may consist of computer-executable instructions stored on computer-readable media or a computer-readable storage device such as one or more non-transitory memories or other types of hardware-based storage devices, either local or networked. The software may be executed on a digital signal processor, application-specific integrated circuit (ASIC), programmable data plane chip, field-programmable gate array (FPGA), microprocessor, or other type of processor operating on a computer system, turning such a computer system into a specifically programmed machine.

An in-vehicle system uses image data that includes a representation of a face of a person to determine a gaze direction of the person. The gaze direction follows the rays projected from the pupils of the person's eyes to a point at which the person is looking. The gaze direction for each eye can be considered as the visual axis of the eye of the person in 3D space where the ray starts at the center of the eye and passes through the center of the pupil of the eye. The gaze direction for a person may be computed as the mean of the gaze directions of the left and right eyes of the person.

In alternative embodiments, a head pose and a gaze point of the person may be used. The gaze point is a point at which the person is looking, as determined by the convergence point of rays projected from the pupils of the person's eyes. The gaze point may be calculated from an image that depicts the eyes by estimating a position of the center of each eye and calculating where the ray for one eye that originates at the center of the eye and passes through the pupil intersects with the corresponding ray for the other eye. In a spherical coordinate system, the gaze direction can be considered as the angular components (polar and azimuthal angles) of the gaze point which also have a third component of radial distance, in this case the distance of the gaze point from the eye pupil center.

The system causes a camera to capture visual data (e.g., take a picture) from a region identified by the gaze point. For example, a computer integrated into the vehicle may send a signal to the camera via a bus. When the camera receives the signal, the camera may respond by capturing visual data (e.g., by detecting light hitting a charged-coupled device (CCD)). The capture of the visual data may be in response to detection of a gesture by the person. A gesture is an input generated by a user that includes a motion of a body part (e.g., a hand or an eye) of the user. In some example embodiments, the system is integrated into a vehicle and the person is a driver of the vehicle. By using gaze direction detection (and, as in alternative embodiments, head pose direction detection or gaze point detection) to identify the region to be photographed and a hand gesture to cause the image capture, the system enables the photograph to be captured without the driver having to hold a cell phone, reducing the distraction to the driver.

By use of the systems and methods described herein, drivers may be enabled to easily take pictures while avoiding traffic accidents because of a hands-free control system. Additionally or alternatively, drivers may be enabled to participate in social networks (e.g., image-sharing social networks) while driving. No existing system uses the same, non-invasive and comfortable method of taking pictures as the system described herein. For example, wearable glasses that include eye tracking are problematic because the driver may need to remove the glasses to clean the glasses or wipe their face. During the period in which the glasses are removed, the driver will be unable to access their functionality, which is avoided by having the system built into the vehicle instead of the glasses. Moreover, wearing imaging devices increases distraction to the driver.

Additionally, in some existing systems, the driver must focus on a scene of interest for a period of time before the picture is taken. Embodiments described herein that capture an image in response to a hand gesture without requiring a time threshold avoid the risk of extending the driver's attention to the scene of interest instead of to the road, increasing safety.

Compared to a wearable system using hand gestures, systems described herein further improve safety by virtue of a wide angle of the camera used to detect the hand gestures. In other words, a camera mounted in the interior of a vehicle may be able to capture a hand gesture anywhere in the cabin of the vehicle, while a camera mounted to a wearable device will have a narrower field of view and require the user to make the hand gesture within a particular region of space. Thus, the task of making the hand gesture will be less distracting to the driver using systems described herein.

The inventive subject matter is described herein in the context of an image-capturing system for use in a vehicle. However, other embodiments are contemplated. For example, the systems and methods may be adapted for use in hand-held devices, general robotics (e.g., home or entertainment robots), and other industries.

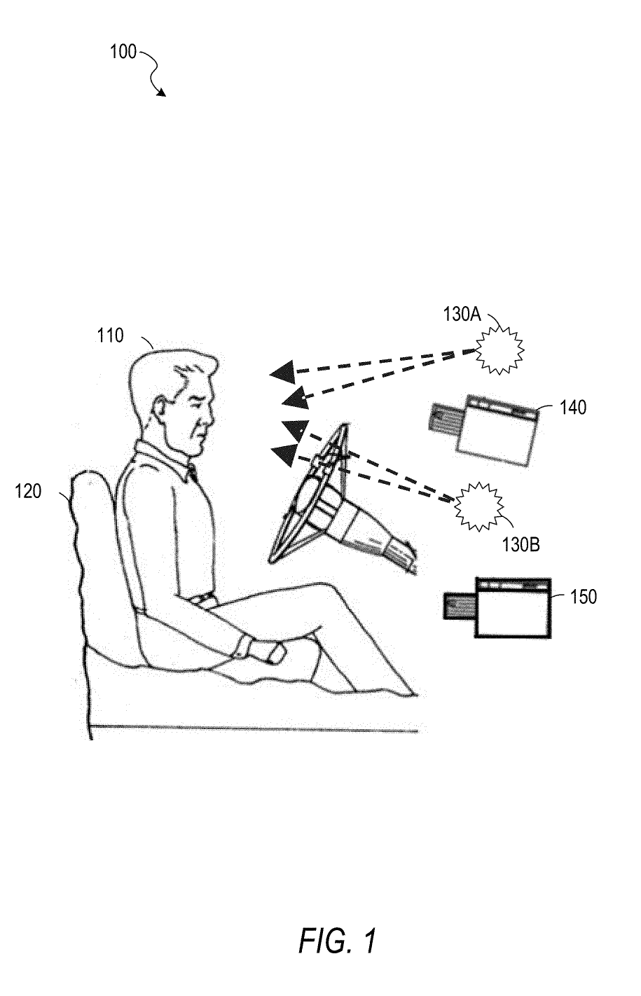

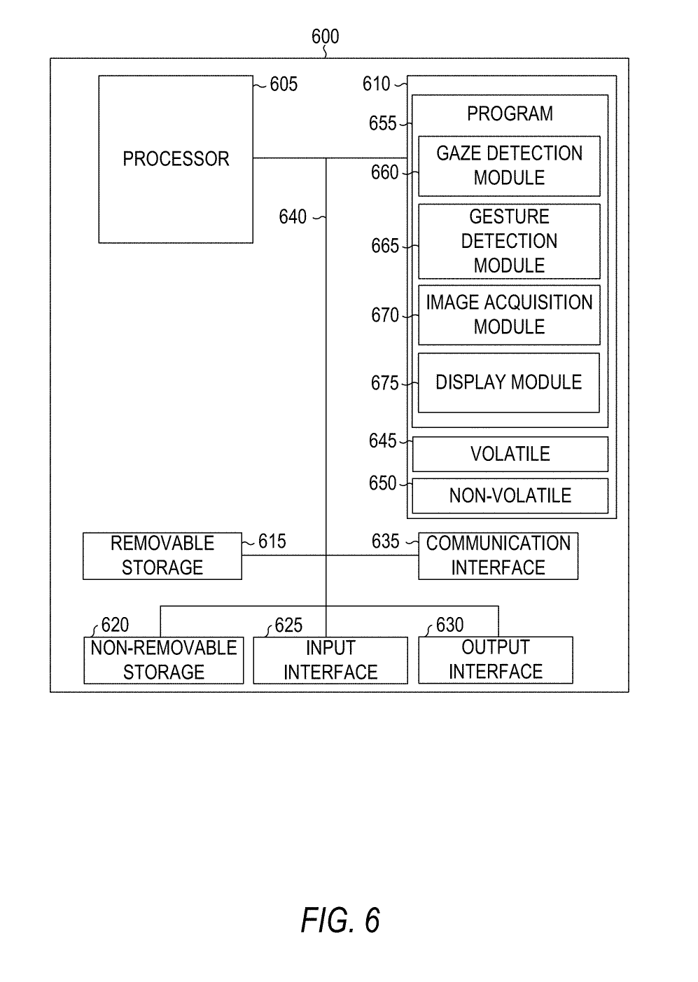

FIG. 1 is an illustration of a vehicle interior 100, according to some example embodiments. Shown in the vehicle interior 100 are a driver 110, a seat 120, light sources 130A and 130B (e.g., near infrared light emitting diodes (LEDs)), and image sensors 140 and 150. Each image sensor may be a camera, a CCD, an image sensor array, a depth camera, or any suitable combination thereof). The light sources 130A-130B and the image sensors 140-150 may be controlled by a computer system such as that described below with respect to FIG. 6. In some example embodiments, the light sources 130A-130B are not present.

The image sensor 140 may be a near-infrared (IR) camera focusing on the driver 110. If the imaging system includes the light sources 130A-130B, the wavelengths of light provided by the light sources 130A-130B may be receivable by the image sensor 140. Images captured by the image sensor 140 may be used to determine the direction and focus depth of the eyes of the driver 110. One method of determining the direction and focus depth of the driver's eyes is to directly estimate their values from the captured images. Another method is to determine the values based on corneal reflections generated by the light generated by the light sources 130A-130B reflecting off of the surface of the eyes of the driver 110. Head pose, the orientation of the driver's head, may also be determined from images captured by the image sensor 140 and used in determining the direction and focus depth of the driver's eyes.

The image sensor 140 may comprise a depth camera that captures stereoscopic images to determine distances of objects from the camera. For example, two near-IR image sensors may be used to determine a three-dimensional head pose. As another example, a time-of-flight camera may be coordinated with the light sources 130A and 130B and determine depth based on the amount of time between emission of light from a light source and receipt of the light (after reflection from an object) at the time-of-flight camera.

The image sensor 150 may detect hand gestures by the driver 110. If the imaging system includes the light sources 130A-130B, the wavelengths of light provided by the light sources 130A-130B may be receivable by the image sensor 150. Images captured by the image sensor 150 may be used to identify gestures performed by the driver 110. For example, the image sensor 150 may be a depth camera used to identify the position, orientation, and configuration of the driver's hands. The image sensor 150 may comprise a depth camera that captures stereoscopic images to determine distances of objects from the camera. For example, two near-IR image sensors may be used to detect a gesture that involves moving toward or away from the image sensor 150. As another example, a time-of-flight camera may be coordinated with the light sources 130A and 130B and determine depth based on the amount of time between emission of light from a light source and receipt of the light (after reflection from an object) at the time-of-flight camera.

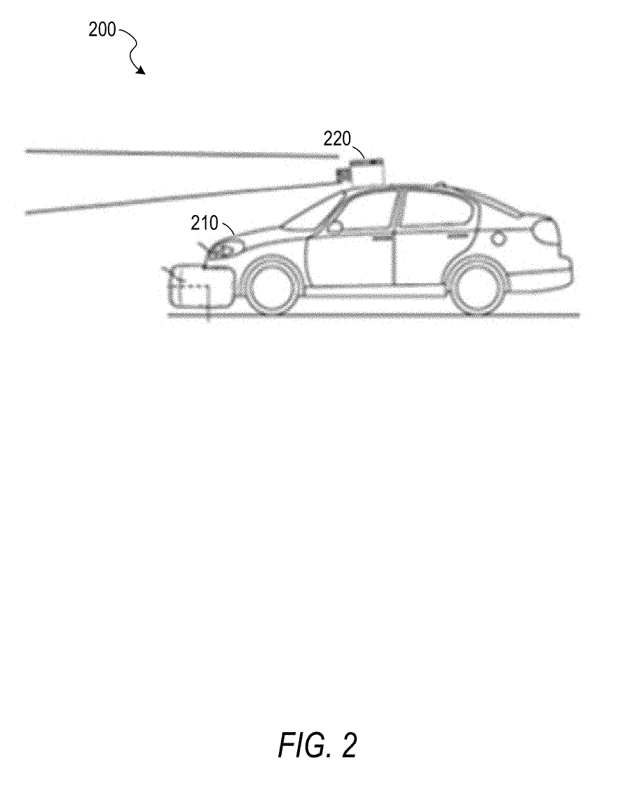

FIG. 2 is an illustration of a vehicle exterior 200, according to some example embodiments. The illustration includes a vehicle 210 and a camera 220. The vehicle 210 may be configured with the vehicle interior 100 of FIG. 1. The camera 220 is mounted on the roof of the vehicle 210 and may be a second camera controlled by the same system controlling the first camera, the image sensor 140 of FIG. 1. The camera 220 may be a wide-angle camera, a 360-degree camera, a rotating camera, or any suitable combination thereof. The camera 220 may be integrated into the vehicle 210 (e.g., sold by the manufacturer as part of the vehicle 210 and permanently attached to the rest of the vehicle 210), securely mounted to the vehicle 210 (e.g., by a gimbal, magnetic tape, tape, bolts, or screws), or temporarily attached to the vehicle 210 (e.g., by being placed in a holder on a dashboard). The vehicle 210 is an automobile, but the inventive subject matter is not so limited and may be used with other vehicles such as aircraft, watercraft, or trains. As used herein, a vehicle is any mechanism capable of motion.

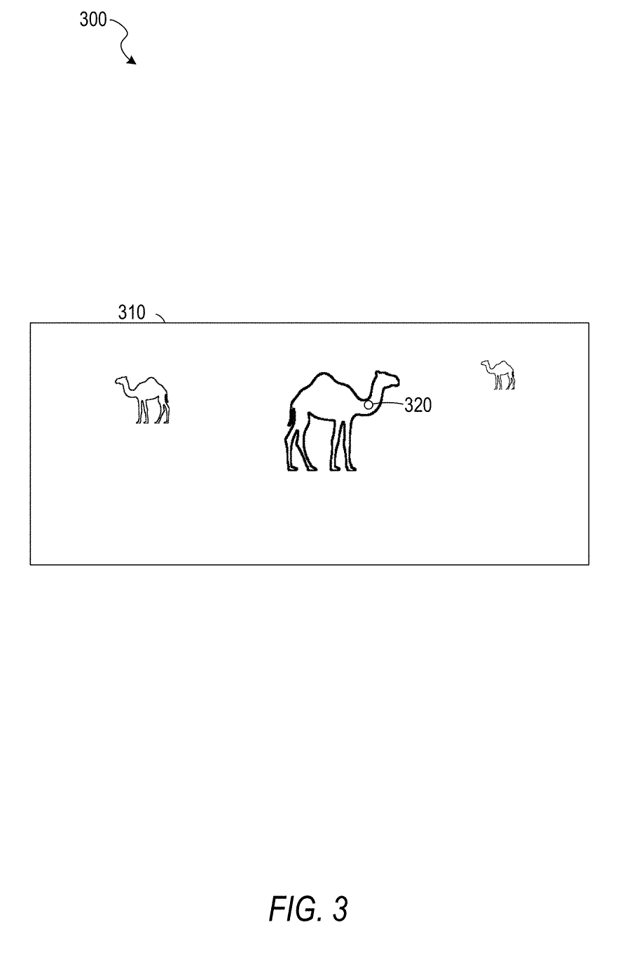

FIG. 3 is an illustration 300 of a view 310 from a vehicle, according to some example embodiments. The view 310 may include a representation of multiple objects at varying distances from the vehicle. A focal point 320 indicates a gaze point of a person (e.g., the driver 110 of the vehicle 210). The focal point 320 may have been determined based on one or more images captured using the image sensor 140.

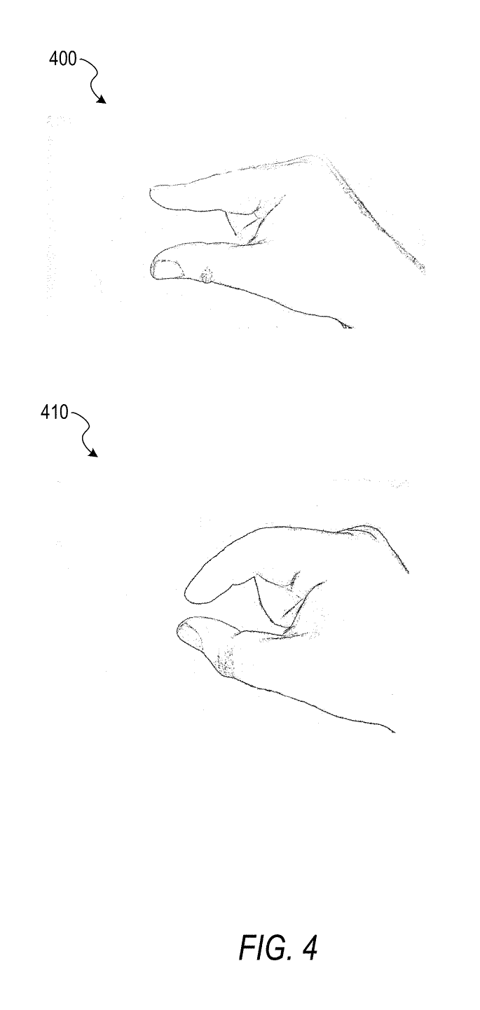

FIG. 4 is an illustration of a gesture, according to some example embodiments. An image 400 shows a hand with thumb and forefinger extended, approximately parallel, and with the remaining fingers closed. An image 410 shows the hand with thumb and forefinger brought closer together. Taken in sequence, the images 400 and 410 show a pinching gesture, wherein the gesture comprises a thumb and a finger of one hand approaching each other.

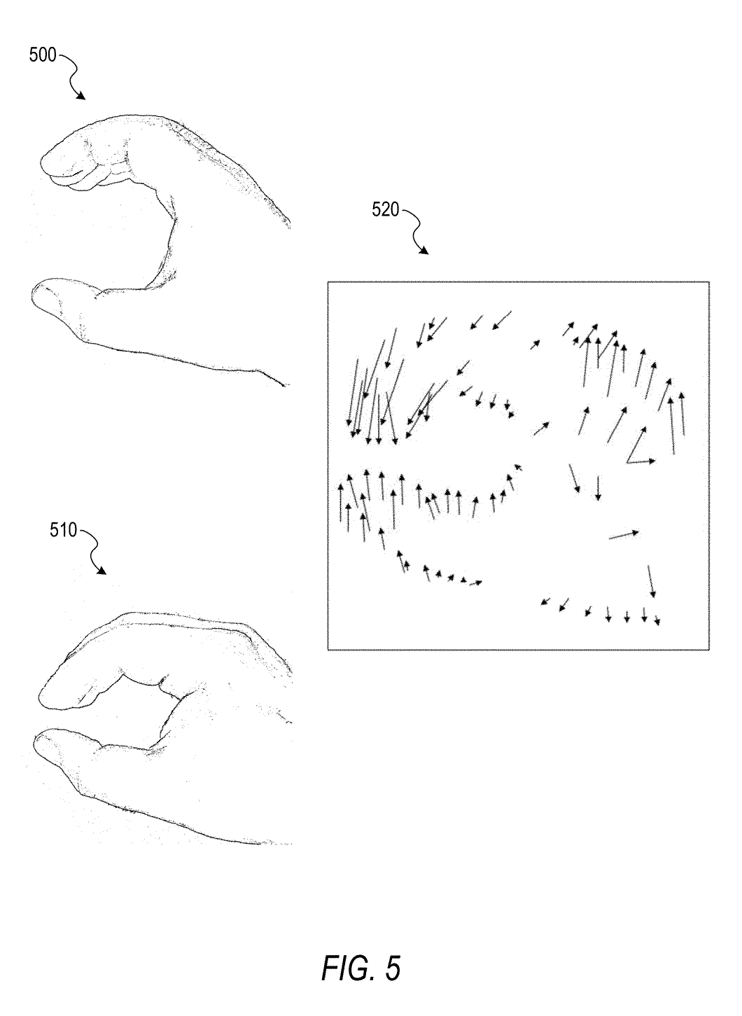

FIG. 5 is an illustration of a gesture, according to some example embodiments. An image 500 shows a hand with fingers loosely curled, making a c-shape with the hand. An image 510 shows the hand with the fingers brought closer to the thumb. Taken in sequence, the images 500 and 510 show a pinching gesture. A diagram 520 shows a motion flow generated from the images 500 and 510. Each arrow in the diagram 520 shows a direction and magnitude of motion of a point depicted in the image 500 moving to a new position in the image 510. The diagram 520 may indicate an intermediate step of image processing in gesture recognition. Use of a gesture sequence shown in FIG. 4 or FIG. 5 to cause acquisition of visual data may be intuitive due to the similarity of the gestures to the physical act of pressing a shutter button on a traditional camera. For example, upon detection of a particular gesture sequence, an in-vehicle computer may send a signal to a camera via a bus. In response to the signal, the camera may acquire visual data (e.g., save to a memory a pattern of visual data received by a CCD).

Other gestures may be used beyond the examples of FIGS. 4-5. For example, an eye gesture such as a wink, a double-blink, or a triple-blink may be detected and used to cause acquisition of visual data.

FIG. 6 is a block diagram illustrating circuitry for a computer 600 that implements algorithms and performs methods, according to some example embodiments. All components need not be used in various embodiments. For example, clients, servers, autonomous systems, network devices, and cloud-based network resources may each use a different set of components, or, in the case of servers for example, larger storage devices.

One example computing device in the form of the computer 600 (also referred to as an on-board computer 600, a computing device 600, and a computer system 600) may include a processor 605, memory storage 610, removable storage 615, and non-removable storage 620, all connected by a bus 640. Although the example computing device is illustrated and described as the computer 600, the computing device may be in different forms in different embodiments. For example, the computing device may instead be a smartphone, a tablet, a smartwatch, or another computing device including elements the same as or similar to those illustrated and described with regard to FIG. 6. Devices such as smartphones, tablets, and smartwatches are generally collectively referred to as “mobile devices” or “user equipment.” Further, although the various data storage elements are illustrated as part of the computer 600, the storage may also or alternatively include cloud-based storage accessible via a network, such as the Internet, or server-based storage.

The memory storage 610 may include volatile memory 645 and non-volatile memory 650, and may store a program 655. The computer 600 may include, or have access to a computing environment that includes, a variety of computer-readable media, such as the volatile memory 645, the non-volatile memory 650, the removable storage 615, and the non-removable storage 620. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

The computer 600 may include or have access to a computing environment that includes an input interface 625, an output interface 630, and a communication interface 635. The output interface 630 may interface to or include a display device, such as a touchscreen, that also may serve as an input device. The input interface 625 may interface to or include one or more of a touchscreen, a touchpad, a mouse, a keyboard, a camera, one or more device-specific buttons, one or more sensors integrated within or coupled via wired or wireless data connections to the computer 600, and other input devices. The computer 600 may operate in a networked environment using the communication interface 635 to connect to one or more remote computers, such as database servers. The remote computer may include a personal computer (PC), server, router, switch, network PC, peer device or other common network node, or the like. The communication interface 635 may connect to a local-area network (LAN), a wide-area network (WAN), a cellular network, a WiFi network, a Bluetooth network, or other networks.

Though the computer 600 is shown as having a single one of each element 605-675, multiples of each element may be present. For example, multiple processors 605, multiple input interfaces 625, multiple output interfaces 630, and multiple communication interfaces 635 may be present. In some example embodiments, different communication interfaces 635 are connected to different networks.

Computer-readable instructions stored on a computer-readable medium (e.g., the program 655 stored in the memory storage 610) are executable by the processor 605 of the computer 600. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed in and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example.

The program 655 is shown as including a gaze detection module 660, a gesture detection module 665, an image acquisition module 670, and a display module 675. Any one or more of the modules described herein may be implemented using hardware (e.g., a processor of a machine, an ASIC, an FPGA, or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The gaze detection module 660 determines a focal point of a person's gaze based on one or more images of the person. For example, the image sensor 140 may be focused on the driver 110 and capture an image of the driver 110 periodically (e.g., every 200 ms). The images captured by the image sensor 140 may be used by the gaze detection module 660 to determine the direction and focus depth of the gaze of the driver 110, for example, by directly estimating their values from the captured images or based on corneal reflections generated by the light generated by the light sources 130A-130B reflecting off of the surfaces of the eyes of the driver 110.

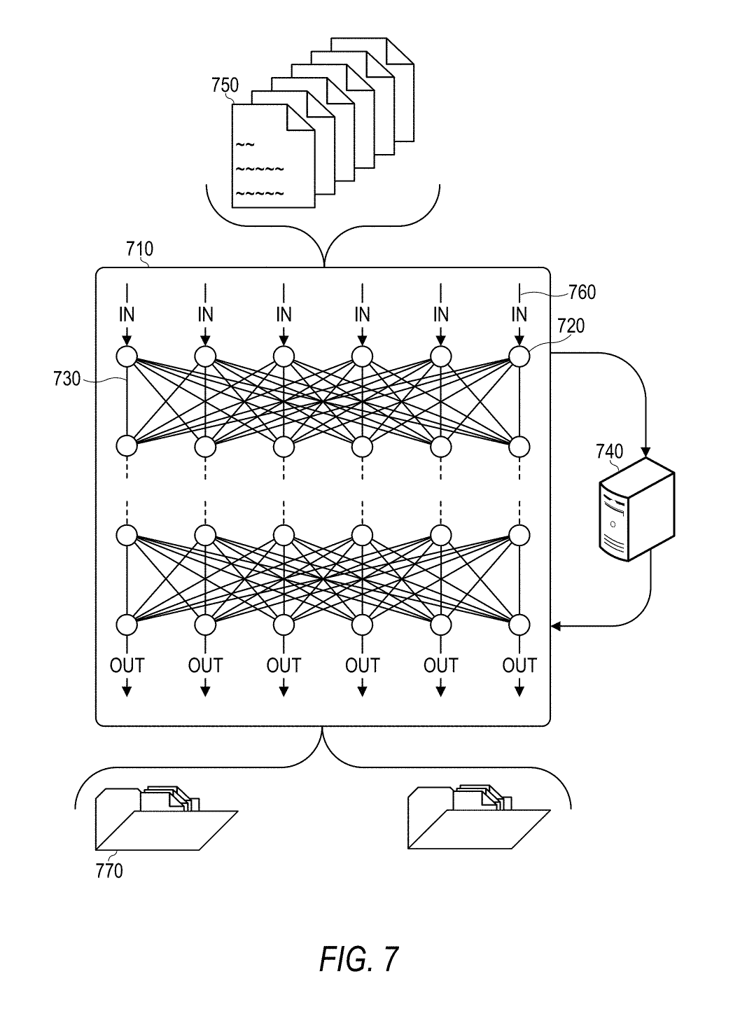

Gaze detection may be performed using an appearance-based approach that uses multimodal convolutional neural networks (CNNs) to extract key features from the driver's face to estimate the driver's gaze direction. The multimodal CNNs may include convolutional layers, pooling layers, and fully connected layers. Convolutional layers apply a series of carefully designed convolutional filters with different size of kernels on the face image to get driver's headpose orientation. Combined with driver's eye image, another multimodal CNN is applied to the eye region, generating a 3D gaze vector as output. The coordinates of the gaze vector are fixed on the driver's head and will move and rotate according to the driver's head movement. With depth image of driver's face or camera calibration, the 3D relationship (e.g., a transform matrix) between the driver's head coordinates and near IR camera's coordinates is defined. Accordingly, the final gaze point may be determined computationally from the determined head pose and eye features or by another trained CNN. In some example embodiments, gaze detection is performed at a fixed frame rate (e.g., 30 frames per second). A CNN is a form of artificial neural network, discussed in greater detail with respect to FIG. 7, below.

Gaze detection may be performed based on corneal reflections generated by the light generated by the light sources 130A-130B (if applicable) reflecting off of the surfaces of the eyes of the driver 110. Based on biomedical knowledge about the human eyeball as well as the geometric relationships between the positions of the light sources and the images of corneal reflections in the camera, the detection of the corneal reflections in the driver's eyes is a theoretically sufficient condition to estimate the driver's gaze direction. In some example embodiments, gaze detection is performed at a fixed frame rate (e.g., 30 frames per second).

In an example embodiment, a residual network (ResNet) is used with 1×1 or 3×3 filters in each component CNN, a rectified linear unit (RELU) activation function, and a shortcut connection between every three convolutional layers. This ResNet allows for extraction of eye and head pose features. The three-dimensional gaze angle is calculated by two fully connected layers, in which each unit connects to all of the feature maps of the previous convolutional layers.

The gesture detection module 665 detects gesture inputs based on one or more images of a person's hand. For example, the image sensor 140 may have a field of view sufficient to capture both the driver's eyes and the driver's hands in a single image. As another example, two cameras may be placed in the vehicle interior 100, one focused on the driver's eyes and the other focused on the driver's hands. Based on a sequence of images, in which a hand can be static or moving throughout all images of the sequence, a gesture may be detected. Example gestures include the gestures of FIG. 4 and FIG. 5. Other example gestures include swipes (hand or finger motions in approximately straight lines), dynamic spreads (motions in which two points (e.g., fingertips) are moved apart), or static spreads (where two points (e.g., fingertips) are separated apart statically throughout frames). The static spread signal may be used as a pre-capturing gesture to tell the system of the intention of taking a picture of the scene in view based on the gaze direction. Since tracking dynamic gestures may consume more computational resources (e.g., by using a sequence of frames) than tracking static gestures (e.g., which may be tracked frame by frame), a frame by frame gesture capturing can be used to then trigger the dynamic gesture detection to capture a picture.

Gesture detection may be performed using deep learning algorithms or other algorithms. These algorithms may include, but are not limited to, temporal segment long-short term memory (TS-LSTM), that receives a sequence of images as an input and identifies a gesture (or the fact that no gesture was detected) as an output.

The image acquisition module 670 acquires visual data based on a detected gaze point, a detected gesture input, or both. For example, the camera 220 may continuously acquire visual data of a region outside of the vehicle 210 based on the gaze point of the driver 110 being a point outside of the vehicle 210. As another example, the camera 220 may capture a still image of a region identified by the gaze point in response to detection of a predetermined gesture.

The display module 675 displays data on a display device (e.g., a screen built into a vehicle, a screen of a mobile device, or a heads-up display (HUD) projected on a windscreen). For example, visual data acquired by the image acquisition module 670 may be displayed by the display module 675. Additional data and user interface controls may also be displayed by the display module 675.

Thus, an in-vehicle system comprising: at least one gaze/headpose near infrared tracking camera (the image sensor 140); at least one hand gesture tracking depth camera (the image sensor 150); at least one camera looking at the scenery outside the vehicle (the camera 220); at least one computational device (an in-vehicle computer 600) to which each of the aforementioned sensors are connected to, wherein the computational device gathers data from the aforementioned sensors to capture a driver's specific gaze/headpose and hand gestures causing the outwards-looking camera to take a picture or record a video of the scenery outside of the vehicle.

FIG. 7 is a block diagram of an example of an environment including a system for neural network training, according to some example embodiments. The system includes an artificial neural network (ANN) 710 that is trained using a processing node 740. The ANN 710 comprises nodes 720, weights 730, and inputs 760. The ANN 710 may be trained using training data 750, and provides output 770, categorizing the input 760 or training data 750. The ANN 710 may be part of the gaze detection module 660, the gesture detection module 665, or both.

ANNs are computational structures that are loosely modeled on biological neurons. Generally, ANNs encode information (e.g., data or decision making) via weighted connections (e.g., synapses) between nodes (e.g., neurons). Modern ANNs are foundational to many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others.

Many ANNs are represented as matrices of weights that correspond to the modeled connections. ANNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the ANN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the ANN processing.

The correct operation of most ANNs relies on correct weights. However, ANN designers do not generally know which weights will work for a given application. Instead, a training process is used to arrive at appropriate weights. ANN designers typically choose a number of neuron layers or specific connections between layers including circular connection, but the ANN designer does not generally know which weights will work for a given application. Instead, a training process generally proceeds by selecting initial weights, which may be randomly selected. Training data is fed into the ANN and results are compared to an objective function that provides an indication of error. The error indication is a measure of how wrong the ANN's result was compared to an expected result. This error is then used to correct the weights. Over many iterations, the weights will collectively converge to encode the operational data into the ANN. This process may be called an optimization of the objective function (e.g., a cost or loss function), whereby the cost or loss is minimized

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value, or exhibit other undesirable behavior. Variable step sizes may be attempted to provide faster convergence without the downsides of large step sizes.

Backpropagation is a technique whereby training data is fed forward through the ANN—here “forward” means that the data starts at the input neurons and follows the directed graph of neuron connections until the output neurons are reached—and the objective function is applied backwards through the ANN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of ANNs.

The processing node 740 may be a CPU, GPU, field programmable gate array (FPGA), digital signal processor (DSP), application specific integrated circuit (ASIC), or other processing circuitry. In an example, multiple processing nodes may be employed to train different layers of the ANN 710, or even different nodes 720 within layers. Thus, a set of processing nodes 740 is arranged to perform the training of the ANN 710.

The set of processing nodes 740 is arranged to receive a training set 750 for the ANN 710. The ANN 710 comprises a set of nodes 720 arranged in layers (illustrated as rows of nodes 720) and a set of inter-node weights 730 (e.g., parameters) between nodes in the set of nodes. In an example, the training set 750 is a subset of a complete training set. Here, the subset may enable processing nodes with limited storage resources to participate in training the ANN 710.

The training data may include multiple numerical values representative of a domain, such as red, green, and blue pixel values and intensity values for an image or pitch and volume values at discrete times for speech recognition. Each value of the training, or input 760 to be classified once ANN 710 is trained, is provided to a corresponding node 720 in the first layer or input layer of ANN 710. The values propagate through the layers and are changed by the objective function.

As noted above, the set of processing nodes is arranged to train the neural network to create a trained neural network. Once trained, data input into the ANN will produce valid classifications 710 (e.g., the input data 760 will be assigned into categories), for example. The training performed by the set of processing nodes 720 is iterative. In an example, each iteration of the training the neural network is performed independently between layers of the ANN 710. Thus, two distinct layers may be processed in parallel by different members of the set of processing nodes. In an example, different layers of the ANN 710 are trained on different hardware. The members of different members of the set of processing nodes may be located in different packages, housings, computers, cloud based resources, etc. In an example, each iteration of the training is performed independently between nodes in the set of nodes. This example is an additional parallelization whereby individual nodes 720 (e.g., neurons) are trained independently. In an example, the nodes are trained on different hardware.

In some example embodiments, the training data 750 for an ANN 710 to be used as part of the gaze detection module 660 comprises images of drivers and corresponding gaze points. Through an iterative training process, the ANN 710 is trained to generate output 770 for the training data 750 with a low error rate. Once trained, the ANN 710 may be provided one or more images captured by the interior-facing camera 140, generating, as output 760, a gaze point.

In some example embodiments, the training data 750 for an ANN 710 to be used as part of the gesture detection module 665 comprises images of drivers and corresponding gesture identifiers. Through an iterative training process, the ANN 710 is trained to generate output 770 for the training data 750 with a low error rate. Once trained, the ANN 710 may be provided one or more images captured by the interior-facing camera 140, generating, as output 760, a gesture identifier.

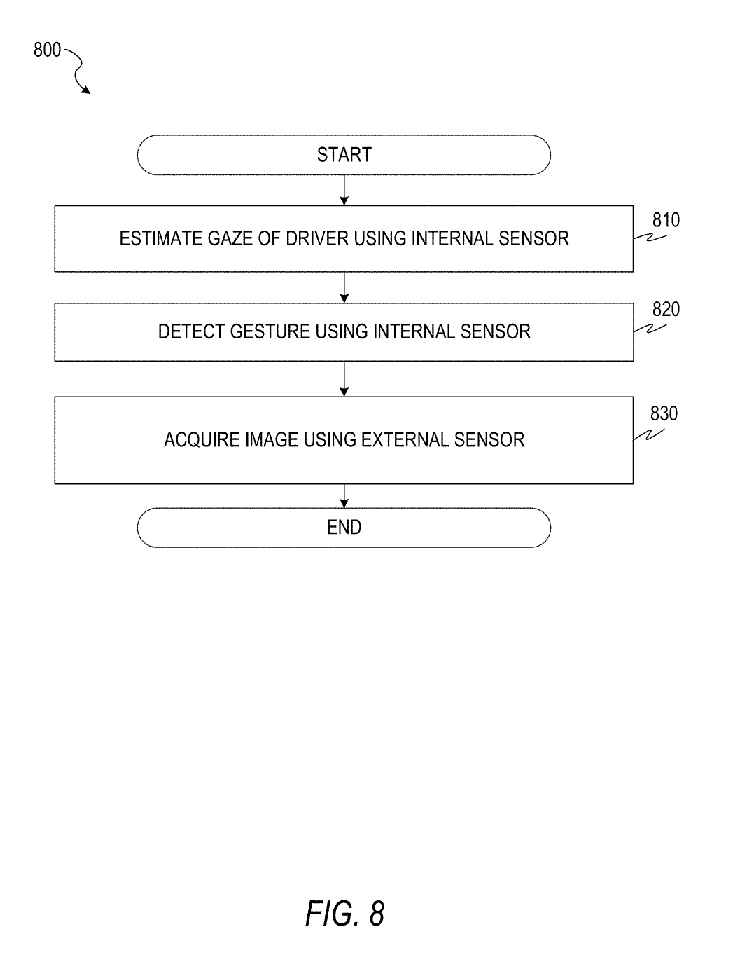

FIG. 8 is a flowchart of a method 800 for acquiring visual data based on gaze and gesture detection, according to some example embodiments. The method 800 includes operations 810, 820, and 830. By way of example and not limitation, the method 800 is described as being performed by elements of the computer 600, described above with respect to FIG. 6, operating as part of a vehicle (e.g., a vehicle comprising the vehicle interior 100 and the vehicle exterior 200). The method 800 may be used to acquire visual data in response to a driver's gesture, wherein the visual data acquired is selected based on the driver's gaze.

In operation 810, the gaze detection module 660 estimates a gaze point of a driver using an internal sensor (e.g., the image sensor 140). For example, the driver may focus on an object to be photographed. In operation 820, the gesture detection module 665 detects a gesture of the driver using the internal sensor. For example, the driver may mime pressing a camera shutter using the gesture shown in FIG. 4, the gesture shown in FIG. 5, or another gesture.

In some example embodiments, configuration gestures are supported. For example, a gesture may be used to zoom in on or zoom out from the gaze point, turn on or turn off a flash, or otherwise modify camera settings. The camera settings may be modified in accordance with the configuration gestures before the image is captured.

In operation 830, the image acquisition module 670 acquires an image using an external sensor (e.g., the camera 220). The external sensor may be controlled in accordance with the estimated gaze point. For example, the camera 220 may be focused on the focal point 320 of FIG. 3, such that the captured image will be focused on the center animal. In some example embodiments, camera settings are modified to compensate for motion of the vehicle. For example, a shorter exposure may be used when the vehicle is moving faster to reduce motion blur, thus compensating for a speed of the vehicle. As another example, a rotating camera may track the identified gaze point and turn as the vehicle moves to keep the gaze point in the center of the image during exposure. A gimbal may be used to compensate for the vibration of the vehicle to acquire stabilized video or clear images. An electronic stabilizer may also (or alternatively) be applied after video recording. Example electronic stabilization techniques include optical image stabilization (OIS) and electronic image stabilization (EIS).

In some example embodiments, the external sensor is a 360 degree panoramic image sensor that captures the entire scene outside the vehicle in response to detection of the gesture. Once the entire scene is captured, the captured image is cropped based on the estimated gaze point of the driver at the time the gesture was detected. In this example embodiment, autofocus may be avoided, reducing the cost of the system, and increasing the speed at which the picture is taken. In other words, since the panoramic camera does not need to be focused on a particular region before the image is captured, the picture can be taken more quickly. Post-processing techniques in a separate function, also inside the computational unit, can then be used in order to remove unnecessary parts of the image.

In some example embodiments, a button integrated into the steering wheel is pressed by the driver instead of using a gesture. Thus, in these example embodiments, the driver identifies the portion of the scenery to capture in an image by looking at the desired region and causes the image to be captured by pressing a physical button. In addition to the steering wheel buttons, a touch screen display or button located on the radio panel of the vehicle can also be used as a secondary button for taking pictures. These diversity of options allow the drivers to choose which way they can take pictures of their favorite scenery while driving, while at the same time avoid heavy mental workloads that can cause distraction, and further lead to a traffic accident or violation.

In further example embodiments, the computer 600 uses machine learning in order to decide for itself when to take pictures, or record videos. These alternative embodiment would free the driver from remembering to take a picture when an interesting scenery appears on the road. Using machine learning a computational device on the car (e.g., the vehicle's computer) can learn from the driver what type of scenery the driver enjoys. For instance, if the driver enjoys taking pictures of mountains, then the system could learn to take pictures of mountains automatically whenever the image sensor perceives mountains in the vicinity of the image sensor's field of view.

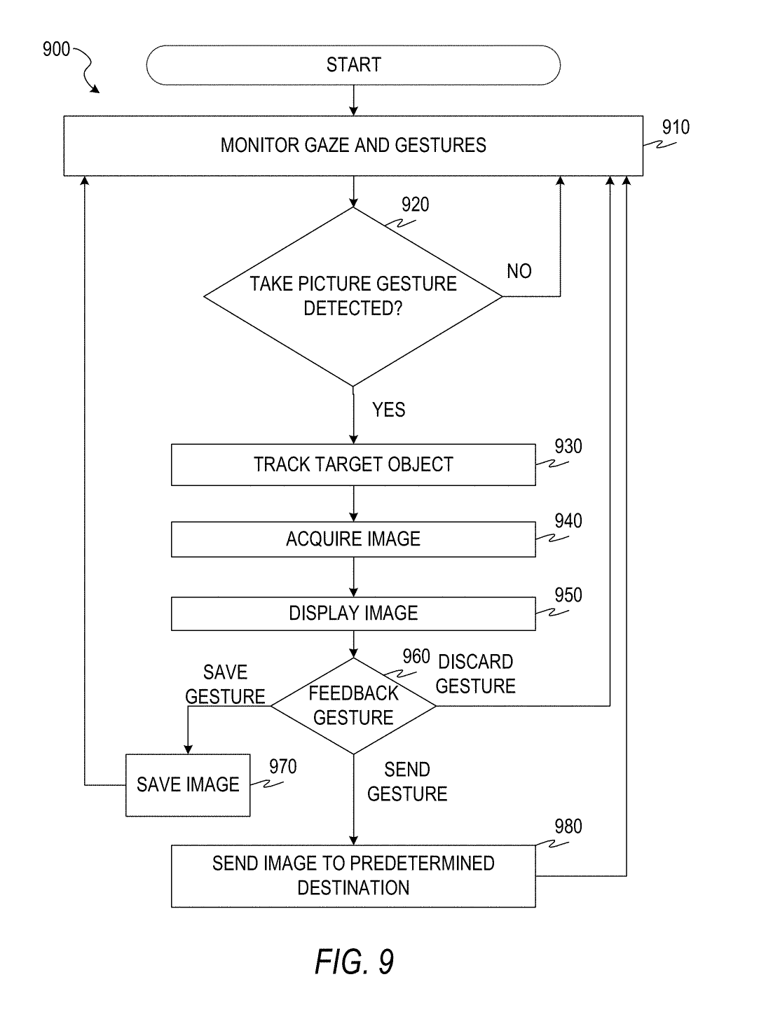

FIG. 9 is a flowchart of a method 900 for acquiring visual data based on gaze and gesture detection, according to some example embodiments. The method 900 includes operations 910, 920, 930, 940, 950, 960, 970, and 980. By way of example and not limitation, the method 900 is described as being performed by elements of the computer 600, described above with respect to FIG. 6, operating as part of a vehicle (e.g., a vehicle comprising the vehicle interior 100 and the vehicle exterior 200). The method 900 may be used to acquire visual data in response to a driver's gesture, wherein the visual data acquired is selected based on the driver's gaze. Furthermore, the method 900 allows the driver to control disposition of the acquired visual data.

In operation 910, the gaze detection module 660 and the gesture detection module 665 monitor a driver's gaze and gestures. For example, the image sensor 140 may periodically generate an image for processing by the gaze detection module 660 and the gesture detection module 665. The gaze detection module 660 may update a gaze point for the driver in response to each processed image. The gesture detection module 665 may use a set of finite-state machines (FSMs), one for each known gesture, and update the state of each FSM in response to each processed image. Once an FSM has reached an end-state corresponding to detection of the corresponding gesture, the gesture detection module 665 may provide a gesture identifier corresponding to the gesture. For example, a swipe-left gesture may have a gesture identifier of 1, a swipe-right gesture may have a gesture identifier of 2, and the gesture of FIG. 4 may have a gesture identifier of 3. The gesture identifier may be used as a primary key in a gesture database and, based on the gesture identifier, a corresponding action triggered.

In operation 920, if the gesture detection module 665 has detected a “take picture” gesture (e.g., the gesture of FIG. 4 or FIG. 5), the method 900 continues with operation 930. Otherwise, the method 900 returns to operation 910, to continue monitoring the driver's gaze and gestures.

In operation 930, the image acquisition module 670 tracks a target object identified based on the driver's gaze. For example, a first image may be captured using the camera 220 for processing by an object recognition algorithm. If the driver's gaze point is within a depicted recognized object, that object may be determined to be the target object for image acquisition. Additional images that include the identified object may be captured by the camera 220 and processed to determine a path of relative motion between the object and the vehicle. Using the determined path of relative motion, the direction and depth of focus of the camera 220 may be adjusted so that a following acquired image, acquired in operation 940, is focused on the identified object. Adjustment of the camera's direction may be accomplished using a servo.

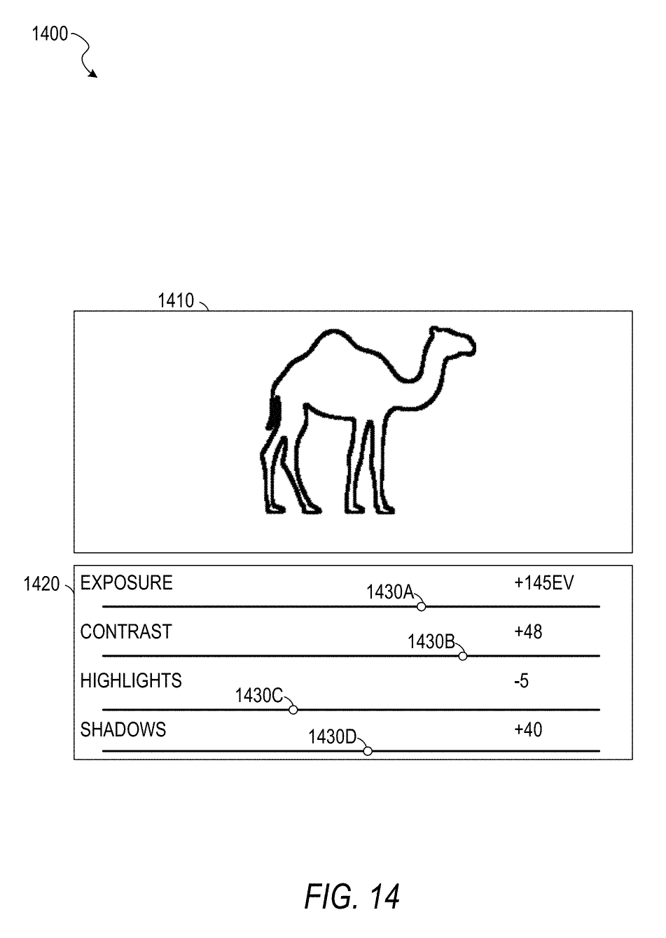

In operation 950, the display module 675 displays the acquired image on a display device (e.g., a screen built into the vehicle or a screen of a mobile device tethered to the vehicle via Bluetooth). In some example embodiments, the example user interface 1400 of FIG. 14, described below, is used.

Operation 960 determines the next operation based on a feedback gesture detected by the gesture detection module 665 (e.g., based on a gesture identifier generated by the gesture detection module 665). If the gesture is a “save” gesture (e.g., a downward swipe), the image is saved in operation 970 (e.g., to a storage device built into the vehicle or storage of a mobile device tethered to the vehicle via Bluetooth). If the gesture is a “discard” gesture (e.g., a leftward swipe), the image is discarded. If the gesture is a “send” gesture (e.g., a rightward swipe), the image is sent to a predetermined destination (e.g., a social network, an email address, or an online storage folder) in operation 980. After disposition of the image based on the feedback gesture, the method 900 returns to operation 910.

The captured image may be modified to include a visible watermark that indicates that the image was captured using an in-vehicle image capturing system. A social network that receives the image may detect the visible watermark and process the received image accordingly. For example, the image may be tagged with a searchable text tag for easy recognition and retrieval.

In some example embodiments, editing gestures are supported. For example, a gesture may be used to zoom in on the image; zoom out from the image; crop the image; pan left, right, up, or down; or any suitable combination thereof. The image may be modified in accordance with the editing gesture before being saved, discarded, or sent. Additionally or alternatively, editing may be supported through the use of a touchscreen. For example, the driver or a passenger may write on the image with a fingertip using a touchscreen or gestures.

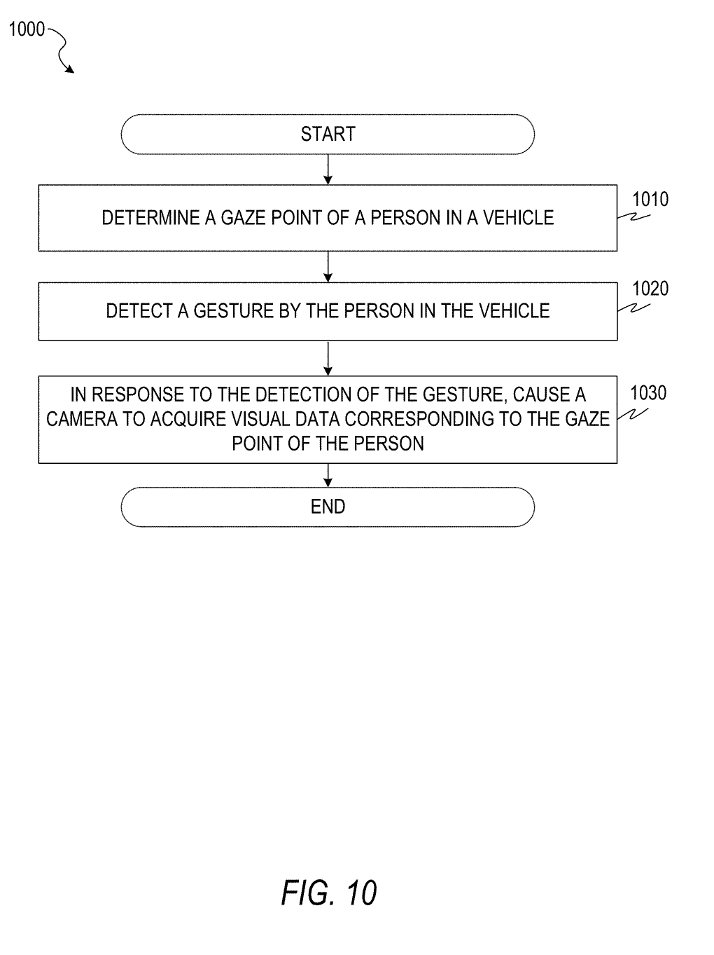

FIG. 10 is a flowchart of a method 1000 for acquiring visual data based on gaze and gesture detection, according to some example embodiments. The method 1000 includes operations 1010, 1020, and 1030. By way of example and not limitation, the method 1000 is described as being performed by elements of the computer 600, described above with respect to FIG. 6, operating as part of a vehicle (e.g., a vehicle comprising the vehicle interior 100 and the vehicle exterior 200). The method 1000 may be used to acquire visual data in response to a driver's gesture, wherein the visual data acquired is selected based on the driver's gaze.

In operation 1010, the gaze detection module 660 determines a gaze point of a person in the vehicle (e.g., based on images captured by the image sensor 140). For example, the driver may focus on an object to be photographed. In operation 1020, the gesture detection module 665 detects a gesture of the person (e.g., based on images captured by the image sensor 140).

In operation 1030, the image acquisition module 670, in response to the detection of the gesture, causes a camera to acquire visual data corresponding to the gaze point of the person (e.g., by causing the camera 220 to focus on the gaze point and then capture an image). In some example embodiments, the causing of the camera to acquire visual data comprises transmitting an instruction to a mobile device. For example, a user may place a cell phone in a tray on a dashboard of a car, such that a camera of the cell phone faces forward and can capture images of objects in front of the car. The cell phone may connect to the image acquisition module 670 via Bluetooth. Thus, the image acquisition module 670 may send a command via Bluetooth to the cell phone, which can respond by capturing an image with its camera.

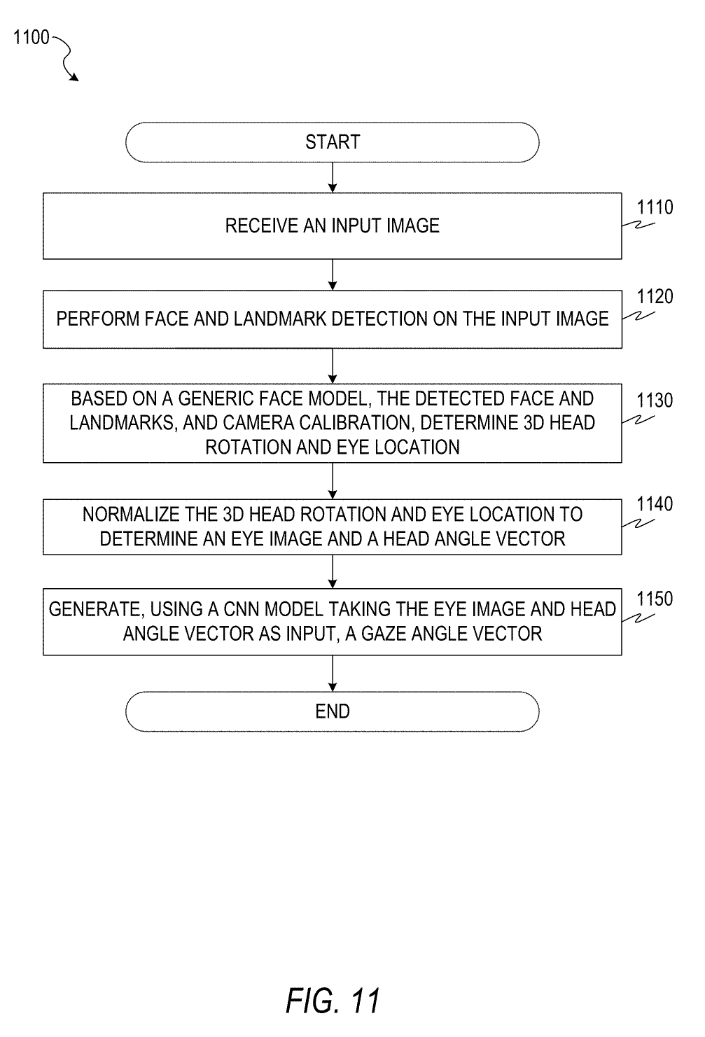

FIG. 11 is a flowchart of a method 1100 for gaze detection, according to some example embodiments. The method 1100 includes operations 1110, 1120, 1130, 1140, and 1150. By way of example and not limitation, the method 1100 is described as being performed by elements of the computer 600, described above with respect to FIG. 6, operating as part of a vehicle (e.g., a vehicle comprising the vehicle interior 100 and the vehicle exterior 200). The method 1100 may be used to detect the driver's gaze.

In operation 1110, the gaze detection module 660 receives an input image. For example, a near IR image captured by the camera 140 may be provided to the gaze detection module 660.

In operation 1120, the gaze detection module 660 performs face and landmark detection on the input image. For example, the image may be provided to a trained CNN as an input and the CNN may provide a bounding box of the face and coordinates of landmarks as an output. Example landmarks include the corners of the eyes and mouth.

In operation 1130, the gaze detection module 660 determines 3D head rotation and eye location based on a generic face model, the detected face and landmarks, and camera calibration. The gaze detection module 660 normalizes the 3D head rotation and eye rotation, in operation 1140, to determine an eye image and a head angle vector. Using a CNN model taking the eye image and the head angle vector as inputs, the gaze detection module 660 generates a gaze angle vector (operation 1150).

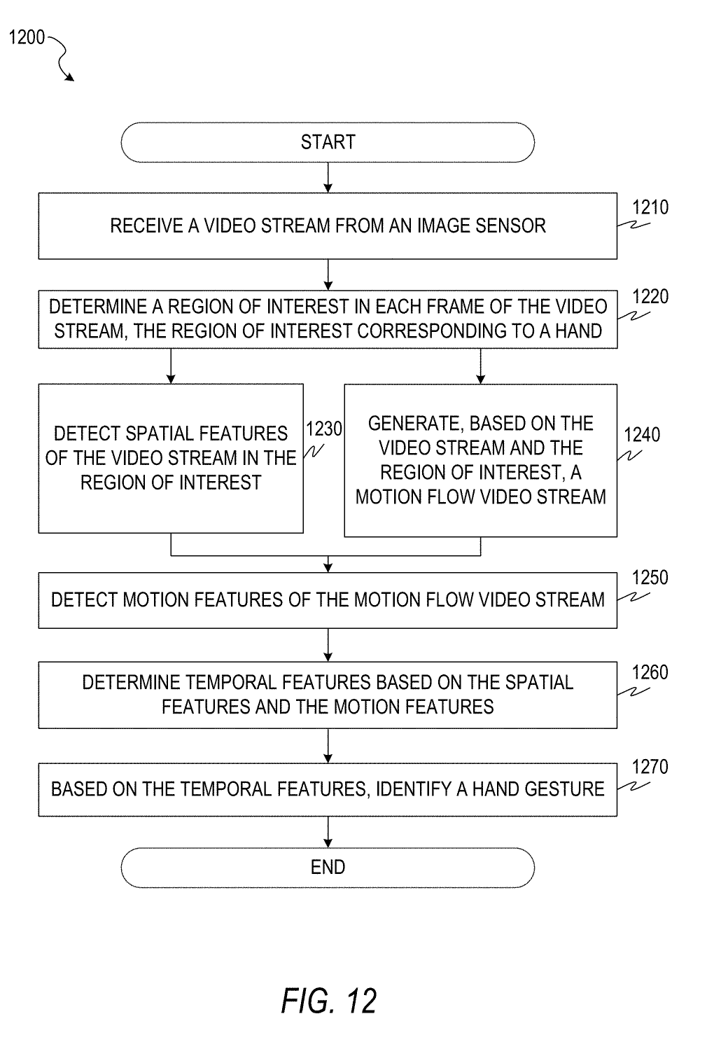

FIG. 12 is a flowchart of a method 1200 for gesture detection, according to some example embodiments. The method 1200 includes operations 1210, 1220, 1230, 1240, 1250, 1260, and 1270. By way of example and not limitation, the method 1200 is described as being performed by elements of the computer 600, described above with respect to FIG. 6, operating as part of a vehicle (e.g., a vehicle comprising the vehicle interior 100 and the vehicle exterior 200). The method 1200 may be used to identify a driver's gesture.

In operation 1210, the gesture detection module 665 receives a video stream from an image sensor (e.g., the image sensor 140). The gesture detection module 665, in operation 1220, determines a region of interest (ROI) in each frame of the video stream, the ROI corresponding to a hand (e.g., the hand of the driver 110 of FIG. 1 or a hand of a passenger). For example, image recognition may be used on each frame of the video stream to determine a bounding box that contains a depiction of a hand, and the bounding box may be used as the ROI. In some example embodiments, the gesture detection module 665 only proceeds with the method 1200 if at least one hand is touching the steering wheel. Whether at least one hand is touching the steering wheel may be determined through image recognition, in response to a signal from a sensor in the steering wheel, or using any suitable combination thereof.

In operation 1230, the gesture detection module 665 detects spatial features of the video stream in the ROI. For example, the algorithm can determine if the hand in the frame is performing a spread gesture, such as in the image 400 from FIG. 4 and the image 500 from FIG. 5, which can also be used as a static gesture (without motion involved) to indicate to the system that a picture of the scene is about to be taken.

Once the hand has been identified and the hand ROI has been generated, the gesture detection module 665 generates, based on the video stream and the ROI, a motion flow video stream (operation 1240). For example, each frame of the motion flow video stream may be similar to the diagram 520 of FIG. 5, graphically depicting the change between frames. For example, an algorithm that computes the motion flow of the hand (e.g., optical flow) may obtain the dynamic characteristics of the hand. Dynamic characteristics are characteristics determined from a sequence of images, such as how fast the pixels representing the hand are moving and the direction of motion of the pixels representing the hand. Thus, in some example embodiments, the algorithm can determine if the hand in the frame is performing the C-like shape static gesture, which is a gesture used to indicate to the system that a picture of the scene is about to be taken. Moreover, another algorithm can be used that combines the spatial and dynamic characteristics of the hand that being tracked by the system. The algorithm can be a classifier that determines the type of gesture the person is doing. The algorithm may be capable of storing in the memory of the computational device the previous and current positions of hand among the sequence of frames. This can help monitor the sequence of actions that the hand is doing.

Since operations 1230 and 1240 independently operate on the video stream received in operation 1210 and the ROI identified in operation 1220, operations 1230 and 1240 may be performed sequentially or in parallel.

In operation 1250, the motion features of the motion flow video stream are detected. In operation 1260, the gesture detection module 665 determines temporal features based on the spatial features and the motion features. In operation 1270, the gesture detection module 665 identifies a hand gesture based on the temporal features. For example, the gesture detection module 665 may implement a classifier algorithm that determines the type of gesture the person is performing. The algorithm may store in the memory of the computer 600 in FIG. 6 data related to the previous and current positions and appearances of the hand among the sequence of frames. The stored data may be used to monitor the sequence of actions that the hand is performing (e.g., the gestures the hand is performing).

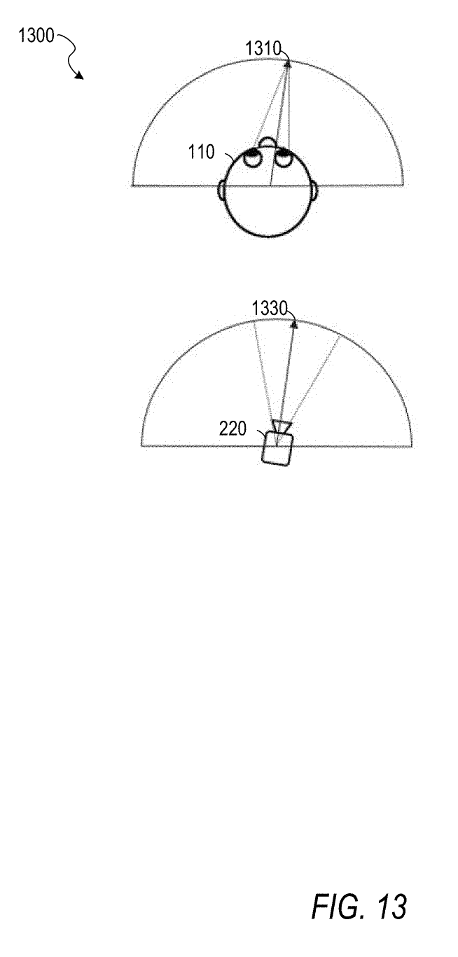

FIG. 13 is an illustration 1300 of the camera 220 following the gaze of the driver 110, according to some example embodiments. A gaze point 1310 is determined by the gaze detection module 660 based on one or more images of the driver's face. A focus point 1320 is set by the image acquisition module 670 by controlling a direction of the camera 220 (e.g., pitch, yaw, roll, or any suitable combination thereof), a depth of focus of the camera 220, a zoom factor for the camera 220, or any suitable combination thereof. The focus point 1320 may be set to be the same as the gaze point 1310 either preemptively (e.g., by continuously tracking the driver's gaze point) or in response to a command to acquire visual data (e.g., in response to detection of a particular gesture or audio command).

FIG. 14 is an illustration of a user interface 1400 showing acquired visual data 1410, according to some example embodiments. The user interface 1400 also includes controls 1420 comprising an exposure slider 1430A, a contrast slider 1430B, a highlights slider 1430C, and a shadows slider 1430D.

The acquired visual data 1410 may be an image acquired in operation 830, 940, or 1030 of the methods 800, 900, or 1000, described above. The user interface 1400 may be displayed by the display module 675 on a display device (e.g., a display device integrated into a vehicle, a heads-up display projected on a windscreen, or a mobile device). Using the sliders 1430A-1430D, the driver or another user may modify the image. For example, a passenger may use a touch screen to move the sliders 1430A-1430D to modify the image. As another example, the driver may use voice controls to move the sliders 1430A-1430D (e.g., a voice command of “set contrast to −20” may set the value of the slider 1430B to −20). In response to the adjustment of a slider, the display module 675 modifies the acquired visual data 1410 to correspond to the adjusted setting (e.g., to increase the exposure, reduce the contrast, emphasize shadows, or any suitable combination thereof). After making modifications (or if no modifications are requested), the user may touch a button on the touch screen or make a gesture (e.g., one of the “save,” “send,” or “discard” gestures discussed above with respect to the method 900) to allow processing of the image to continue.

Although a few embodiments have been described in detail above, other modifications are possible. For example, the logic flows depicted in the figures do not require the particular order shown, or sequential order, to achieve desirable results. Other steps may be provided in, or steps may be eliminated from, the described flows, and other components may be added to, or removed from, the described systems. Other embodiments may be within the scope of the following claims.

What is claimed is:

1. A computer-implemented method of acquiring visual data comprising:
determining, by one or more processors, a gaze point of a person in a vehicle;
detecting, by the one or more processors, a gesture by the person in the vehicle; and
in response to the detection of the gesture, causing, by the one or more processors, a camera to capture visual data corresponding to the gaze point of the person.

2. The method of claim 1, wherein the gaze point of the person in the vehicle is a point outside of the vehicle.

3. The method of claim 1, wherein the determining of the gaze point of the person comprises determining a head pose of the person.

4. The method of claim 1, wherein the determining of the gaze point of the person comprises determining a gaze direction of the person.

5. The method of claim 1, wherein:
the determining of the gaze point of the person in the vehicle is based on an image captured by a first camera; and
the camera caused to capture the visual data corresponding to the gaze point of the person is a second camera.

6. The method of claim 1, wherein the gesture is a hand gesture.

7. The method of claim 6, wherein the hand gesture comprises a thumb and a finger of one hand approaching each other.

8. The method of claim 1, wherein the causing of the camera to capture the visual data corresponding to the gaze point of the person comprises adjusting a direction of the camera.

9. The method of claim 1, wherein the vehicle is an automobile.

10. The method of claim 1, wherein the vehicle is an aircraft.

11. The method of claim 1, wherein the camera is integrated into the vehicle.

12. The method of claim 1, wherein the causing of the camera to capture the visual data comprises transmitting an instruction to a mobile device.

13. The method of claim 1, further comprising:
detecting a second gesture by the person in the vehicle;
wherein the causing of the camera to capture the visual data corresponding to the gaze point of the person comprises causing the camera to zoom in on the gaze point based on the detection of the second gesture.

14. The method of claim 1, wherein the causing of the camera to capture the visual data corresponding to the gaze point of the person comprises causing the camera to compensate for a speed of the vehicle.

15. A vehicle, comprising:
a memory storage comprising instructions; and
one or more processors in communication with the memory storage, wherein the one or more processors execute the instructions to perform:
determining a gaze point of a person in the vehicle;
detecting a gesture by the person in the vehicle; and
in response to the detection of the gesture, causing a camera to capture visual data corresponding to the gaze point of the person.

16. The visual data acquisition system of claim 15, wherein the gaze point of the person in the vehicle is a point outside of the vehicle.

17. The visual data acquisition system of claim 15, wherein:
the determining of the gaze point of the person in the vehicle is based on an image captured by a first camera; and
the camera caused to capture the visual data corresponding to the gaze point of the person is a second camera.

18. The visual data acquisition system of claim 15, wherein the gesture is a hand gesture.

19. The visual data acquisition system of claim 18, wherein the hand gesture comprises a thumb and a finger of one hand approaching each other.

20. A non-transitory computer-readable medium storing computer instructions for acquiring visual data, that when executed by one or more processors, cause the one or more processors to perform steps of:
determining a gaze point of a person in a vehicle;
detecting a gesture by the person in the vehicle; and
in response to the detection of the gesture, causing a camera to capture visual data corresponding to the gaze point of the person.
